(19) United States
(12) Patent Application Publication
(10) Pub. No.: US 2009/0010736 A1
(43) Pub. Date: Jan. 8, 2009

(54) Washer

(76) Inventor: Christopher Rycroft, Yeadon (GB)

Correspondence Address: ALTMAN & MARTIN, 6 BEACON ST, STE 600, BOSTON, MA, 02108, US

(21) Appl. No.: 12/184,584

(22) Filed: Aug. 1, 2008

Related U.S. Application Data
(62) Division of application No. 10/520,967, filed on Aug. 25, 2005, now abandoned.

(51) Int. Cl. F16B 43/00

(52) U.S. Cl. 411/531

(57) ABSTRACT

A centralizing washer for use in, for example, a plumbing installation in which a pipe is mounted in or connected to an article of sanitaryware creating a gap between the hole in the sanitaryware and the pipe. Projections extend axially from the washer for locating in the gap so as to centralize the washer substantially with respect to the hole in the sanitaryware. Optionally, the washer is splittable, comprising separable parts which are held together by hinge or completely separable. When the washer is in the open configuration, it may be fitted to or removed from the pipe without having to remove the pipe securing nut. To close the washer, the parts are urged together until a key projection locates in a socket. In the closed configuration, the washer substantially encloses the pipe.

### CROSS-REFERENCES TO RELATED APPLICATIONS

The present application is a divisional application of application Ser. No. 10/520,967, filed Aug. 25, 2005 for WASHER in the name of Christopher Rycroft, which is a national phase application of PCT application No. PCT/GB2003/002992 filed Jul. 11, 2003 for WASHER in the name of Christopher Rycroft.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to improvements in a washer for use in plumbing, especially in mounting a tap or connecting pipework to a sink, washbasin or other sanitary unit, such as a toilet cistern.

2. Description of the Related Art

To convey water from a water supply to, for example, a sink, a water supply pipe is connected to a tap mounted on the sink. The tap has a tap head including a water outlet and a valve, a stem having an external thread, and an annular seating flange around the stem. The tap is inserted into a mounting aperture in the sink so that the tap head is located above the sink with the seating flange resting on an upper surface of the sink and the threaded stem is located below the sink. The water supply pipe is connected to the stem by a standard plumbing connection, such as a threaded connector, which includes a sealing washer. To ensure a watertight connection the threaded tap stem may be coated with a sealant, such as PTF tape or BOSS WHITE™ prior to threadably engaging the connector of the supply pipe. Immediately beneath the sink unit, at the point at which the stem emerges, a nut is located on the threaded stem, and a mounting washer is located between the nut and the sink unit. The nut is tightened so that the sink unit is gripped between the washer, below the unit, and the seating flange above it, thus ensuring that the tap is held tightly on the unit and cannot rotate with respect to the unit.

However, these mounting washers are prone to splitting, because of the relatively high pressure exerted on them by the nut, and require relatively frequent replacement. The washers, known because of their shape as “top-hat” washers, usually have substantially square bores. Cracks develop from the corners of the square bore, which subsequently cause the washer to split. It is important to replace damaged top-hat washers because otherwise the tap head will eventually work loose and become free to rotate with respect to the unit when it is used. The tap is attached to a rigid supply pipe which cannot rotate with the tap and therefore the connection between the pipe and the tap is put under stress. If left, the connection will eventually fail, causing a leak.

It is difficult and time-consuming to replace the known top-hat washers, since replacing them requires the plumber to perform a number of steps, as follows:

(1) turning off the house water supply by turning off the main water stop-tap;

(2) opening the tap on the unit to run off any existing house system water;

(3) disconnecting the water supply pipe from the bottom of the threaded stem of the tap;

(4) cleaning off all of the sealant from the threaded stem;

(5) unscrewing the lower tap nut from the stem;

(6) removing the old top-hat washer, by cutting if necessary;

(7) sliding the new top-hat washer up the stem;

(8) re-screwing the lower tap nut up the stem, to hold the new top hat;

(9) placing fresh sealant around the lower part of the stem;

(10) connecting the water supply feed pipe back on to the stem;

(11) turning on the house water supply.

This procedure is often hampered by the fact that the plumbing is usually housed in a small area behind the sink unit, meaning that the plumber has to work in cramped conditions and often he cannot see what he is doing. Such difficulties mean that faulty top-hat washers are often not replaced, but rather other pieces of packing material, such as wood, for example, are used to ensure that the tap stem is held tightly in the unit. This practice is not satisfactory as the wood may easily become dislodged, and the load of the securing nut is not evenly distributed on the underside of the unit. If the top-hat washer is not replaced leaks in the pipe may develop, thus necessitating further expensive and difficult work on the plumbing system.

Similar mounting washers are also used in the introduction of pipes into cisterns. Cisterns, for example, generally have two pipes: a cold feed pipe, and an overflow pipe. The pipes are held to the bottom of the cistern by a nut, a washer and adhesive. The difficulties encountered with the lifetime and replacement of this washer are similar to those outlined above.

A further problem with known methods of introducing pipework into sanitaryware is that often the hole in the sink unit is significantly larger than the diameter of the stem, or pipe member, of the tap which is to be inserted into the hole. This means that the taps must be centered in the hole manually when the tap is being fitted and tightened. Typically there can be a 12 mm difference in the diameter of the hole compared with the diameter of the stem. Therefore to prevent the tap from moving around in the hole the tap must be held onto the unit firmly by the nut. However, a further problem affecting ceramic units in particular is that the ceramic is prone to cracking or chipping when pressure is applied. This means that when the tap is fitted great care must be taken so that the ceramic does not crack when the nut is tightened. If the tap is not centered in the hole in the sanitary unit the ceramic is more likely to crack, since the edge of the nut may catch on the edge of the hole.

### BRIEF SUMMARY OF THE INVENTION

Embodiments of the present invention aim to overcome the difficulties in replacing top-hat washers by providing a washer which can be fitted between the nut and the sanitary unit without the nut being removed from the stem of the tap, thereby eliminating most of the above described steps.

Embodiments of the present invention further aim to provide a washer which centers the tap on the sanitary unit and prevents the tap from moving in the hole when it is fitted.

One aspect of the present invention provides a washer for use in a plumbing installation in which a pipe member is mounted in or connected to an article of sanitaryware, the washer comprising at least first and second parts, the parts being moveable with respect to each other between a first configuration in which they define a bore, such that in use the washer may enclose a pipe member which passes through the bore, and a second configuration in which a pipe may be inserted into or withdrawn from the bore generally radially.

The parts may be completely separable.

Preferably said parts include latch means for allowing the parts to releasably engage each other.

Alternatively the parts may be hingedly attached at an edge region of the washer.

The parts may be held together in the first, closed configuration by a releasable latch.

The releasable latch may comprise a projection and socket.

Alternatively the parts of the washer may be permanently attached together in one region and may be flexible so that the two parts can be urged apart to adopt the second, open configuration.

The two parts may be flexed apart in a direction substantially parallel to the axis of the bore.

Preferably the two parts of the washer are made of plastic and are formed as one piece of plastic.

The washer may include a slot located between the two parts of the washer, which slot may be used for prising apart the two parts of the washer.

An internal surface of the bore may be threaded.

A second aspect of the present invention provides a washer for use in plumbing in which a pipe member passes through a hole in an article of sanitaryware, creating a gap between the hole in the sanitaryware and the pipe member, the washer comprising at least one part having a bore defined therein for receiving the pipe member, and at least one projection extending from the washer in a substantially axial direction, for locating in the gap between the pipe member and the article when the washer is urged against the article in use, so as to centralize the washer substantially with respect to the hole in the article.

Preferably the or each projection is arranged so that when the washer is inserted into a hole in an article of sanitaryware, and the pipe member passes through the washer, the pipe member is located substantially centrally with respect to the hole in the article.

Preferably the one or more projections are flexible so that they may fit into holes of different sizes.

The one or more projections may comprise a split-ring.

The one or more projections may comprise a frusto-cone.

Preferably the one or more projections are resiliently biased radially outwardly against a hole in an article in use.

Preferably the bore is substantially circular.

Preferably there are three projections protruding from the washer in a substantially axial direction. The at least one projection may be flexible, and may have at least one substantially flat bearing surface for bearing against an interior of a hole in an article of sanitaryware.

The interior surface of the bore in the washer may be threaded for engagement with a pipe.

A third aspect of the present invention provides a method of installing a washer on a pipe member the washer comprising two parts which are movable with respect to each other between a closed configuration in which they define a bore therebetween and an open configuration in which a pipe member may be inserted or withdrawn from the bore generally radially with respect to the washer, the method comprising causing the parts of the washer to adopt the open configuration, introducing the pipe member between the parts substantially radially with respect to the washer, and causing the parts of the washer to adopt the closed configuration, thereby substantially enclosing the pipe member within the bore defined by the parts of the washer.

The method may further comprise the step of bringing together two separate parts of the washer around the pipe member and causing the two separate parts to engage to enclose the pipe member.

The method may further comprise the step of causing the two parts of the washer to adopt the closed configuration by hinged movement of the parts.

Alternatively the method may further comprise the step of pressing together the two parts around the pipe member until the two parts make a latching engagement, which latching engagement produces an audible indication, such as a click, to confirm that the latching has occurred.

According to a fourth aspect of the present invention there is provided a method of centralizing a pipe member in a hole in an article of sanitaryware, the pipe member having a pipe portion, the pipe portion being housed in a hole of the sanitaryware, and the diameter of the hole being greater than the diameter of the pipe portion, such that a gap exists between the pipe portion and the hole in the sanitaryware, the method comprising the steps of: fitting a washer to the pipe portion, the washer having at least one projection extending from the washer in a substantially axial direction with respect to the pipe portion, so that the at least one projection extends towards the article of sanitaryware; locating the at least one projection in the gap between the sanitaryware and the pipe portion; tightening the washer against the sanitaryware so that the at least one projection makes a friction fit between the pipe portion and the hole of the sanitaryware so that the pipe member is centralized with respect to the hole in the sanitaryware.

The washer may be openable and movable between a first closed configuration defining a bore and a second open configuration, the step of fitting the washer may further comprise the steps of: opening the washer; engaging the bore of the open washer with the pipe portion; closing the washer around the pipe portion.

### BRIEF DESCRIPTION OF THE DRAWINGS

Preferred embodiments of the invention will now be described by way of example, with reference to the accompanying drawings, in which:

FIG. 1 shows a washer located between a securing nut and a lower surface of a sanitary unit.

FIG. 2 shows a cross section of the washer shown in FIG. 1.

FIG. 3 shows an embodiment of washer in a first, closed configuration;

FIG. 4 shows a split washer in a second, open position;

FIG. 5 shows an embodiment of a washer having centralizing projections for location within an aperture in an article of sanitaryware;

FIG. 6 shows a split washer with centralizing projections, in a closed position;

FIG. 7 shows a split washer with centralizing projections, in an open position;

FIG. 8 shows a split washer with centralizing projections in which the two parts are completely separable;

FIG. 9 shows the split washer of FIG. 8 in a separated position; and

FIG. 10 shows a cross-sectional view of a washer having centralizing projections positioned between a nut and the underside of a sanitary unit.

### DETAILED DESCRIPTION OF THE INVENTION

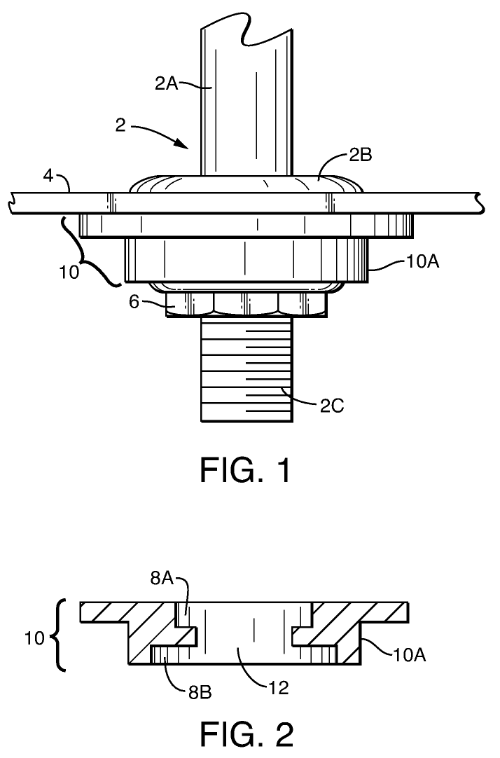

Turning to FIG. 1, this shows a tap unit 2 attached to a sink unit 4. The tap has a head 2a, a flange 2b and a threaded stem 2c. The threaded stem 2c passes through a hole (not shown) in the sink unit 4 and the flange 2b rests against an upper surface of the sink unit 4. A nut 6 is threaded onto the stem 2c of the tap, and a washer 10 is disposed between the nut 6 and the underside of the sink unit 4. The tap unit 2 is held against the sink unit by the flange 2b and the nut 6 and washer 10. From FIG. 1 it can be seen that the washer has a raised portion 10a in the centre. Preferably the raised portion has a larger diameter than the diameter of the nut thereby to spread the load exerted on the washer by the nut and thus lessen the likelihood of the washer splitting. FIG. 2 shows the washer 10 of FIG. 1 in cross section. The washer has an upper recessed portion 8a and a lower recessed portion 8b, and a bore 12 extending right the way through the washer for receiving a pipe (not shown).

In this example the washer is made of molded plastic. The purpose of the upper recessed portion is to accommodate any shoulder of the tap which extends below the underside of the unit and to increase the surface area to volume ratio of the washer, so that when the washer is made the plastic cools more quickly, reducing manufacturing costs. The top of the nut 6 (shown in FIG. 1) fits into the lower recessed portion of the washer 8b. The bore 12 receives the stem 2c of the tap unit 2 (FIG. 1) when the washer is fitted over the tap unit.

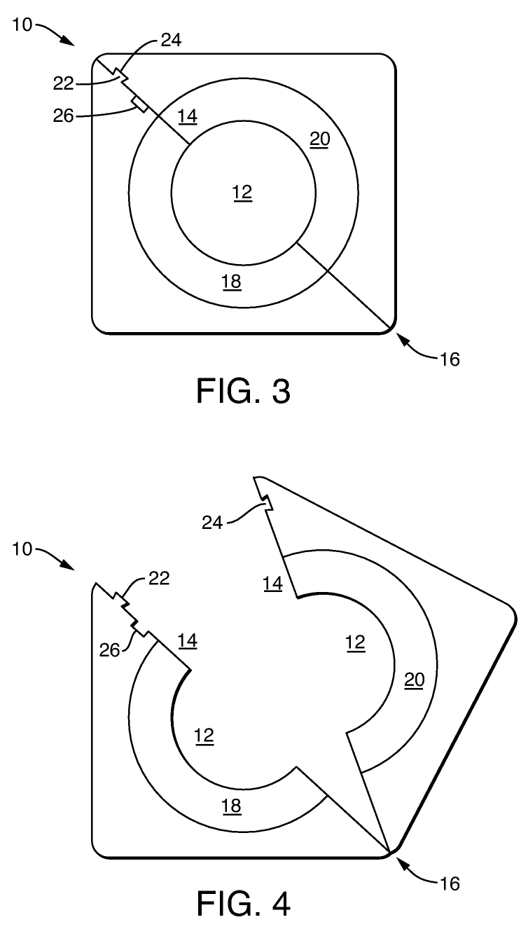

FIG. 3 shows generally at 10 a preferred embodiment of split top-hat washer in accordance with the invention. The washer is shown in its closed position and an aperture 12 is defined in the centre. The washer comprises a single piece of molded plastic and is split down line 14 to form two broadly triangular parts 18 and 20. The two parts remain attached to each other by a hinge in one corner 16 of the washer. The parts 18 and 20 are shaped so that the first part 18 has a key projection 22, and the second part 20 has a socket 24, the projection and the socket being shaped so as to releasably engage with each other. The first part has a further cut-away portion which forms a quick-release slot 26.

The washer is shown in its open position in FIG. 4. To open the washer a screwdriver or a similar tool is inserted into the quick release slot 26. The first and second parts of the washer are then urged apart whilst still being held together by the hinge 16. Opening the washer in this way allows it to be fitted to and removed from the stem of a tap on the underside of a sanitaryware unit, as shown in FIG. 1, without having to remove the nut from the stem. However, it may be necessary to unscrew the nut 6 partially so that there is more space on the stem within which to fit the washer. The nut should then be tightened so that the washer is urged against the underside of the unit.

To close the washer the first and second portions are simply urged together until the key projection 22 locates in the socket 24. In use the open washer is positioned over the stem, between the nut and the unit so that the stem is located in the aperture 12. The washer is then closed causing the corresponding projection 22 and socket 24 to fit together. Then the washer substantially encloses the stem. It is advantageous if pushing the projection and socket together produces a clicking sound, so that the plumber fitting the washer can hear that the washer has been fitted correctly, since he may not be able to see the washer to verify that this is the case. To prevent the two parts of the washer being forced apart when the nut is tightened the projection and the socket are shaped in a complementary way so that the sides are inclined to each other, with the wider end of the projection further from the first part of the washer, as shown in FIG. 4. The resilient material from which the washer is molded permits the projection and socket to deform resiliently and hence temporarily when they are pressed together or prised apart with sufficient force. It is advantageous for the upper recessed portion 8a to be circular, since if it is square cracks can form at the corners of the square. This in turn can lead to the washer splitting. Thus having a circular aperture increases the lifetime of the washer.

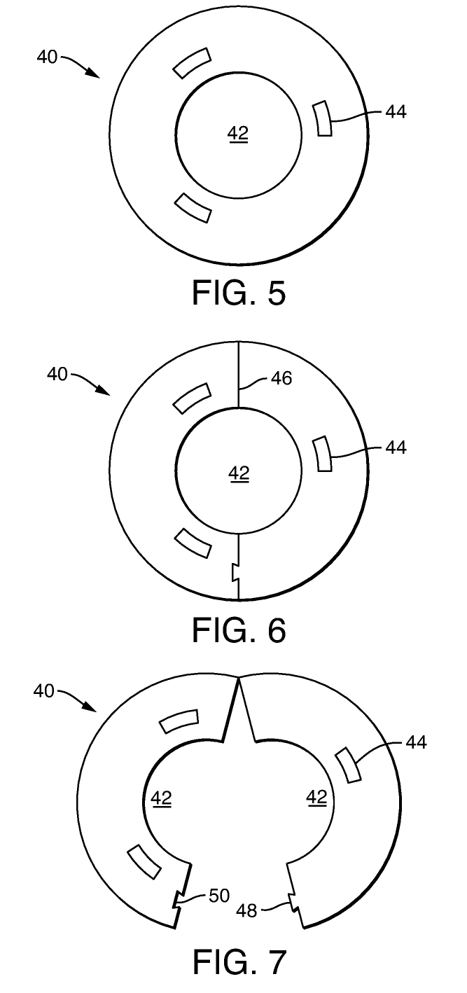

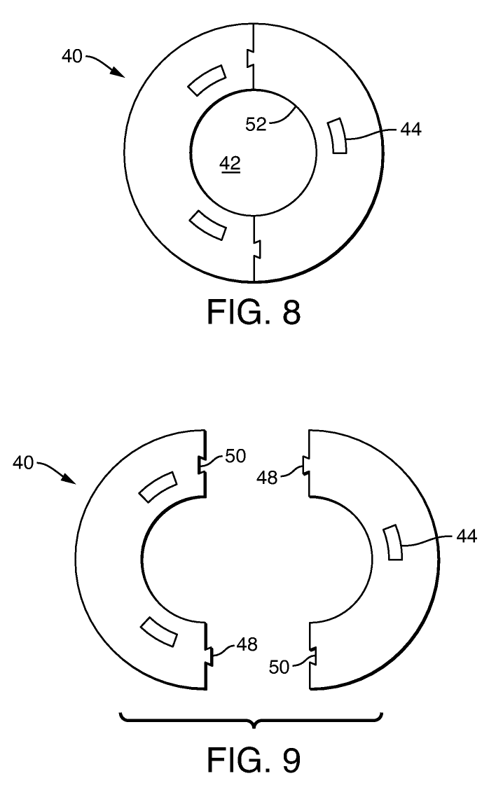

FIG. 5 shows a washer 40 having an aperture 42 and three axially extending centralizing projections 44 for location within a hole in an article of sanitaryware. FIG. 6 shows a split washer, split down line 46, in its closed position. This washer functions in a similar way to the split “top-hat” washer shown in FIGS. 3 and 4. FIG. 7 shows the washer of FIG. 6 in its open position. One portion of the washer has a projection 48 protruding therefrom, and the other provides a corresponding socket 50. FIGS. 8 and 9 show a split washer similar to the one shown in FIGS. 6 and 7. The only difference is that the parts are completely separable as opposed to being hingedly connected. The washers shown in FIGS. 5 to 9 are designed for use in most ceramic sanitaryunits, and therefore are smaller in diameter than those shown in FIGS. 3 and 4, which are generally used in stainless steel sinks. The washers for sink units are usually of a larger size since there is often a larger space under the sink in which the washer can be housed; it is advantageous to have a larger washer since the force exerted by the nut is spread over a larger area of the unit.

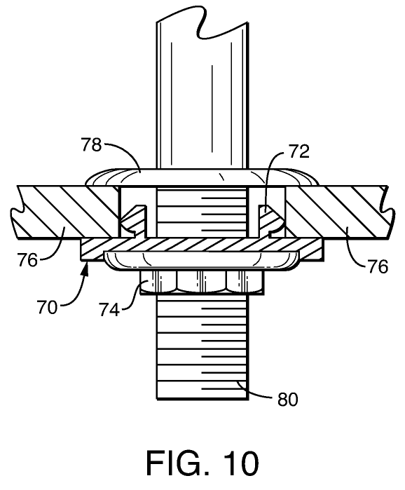

FIG. 10 shows a cross-section of a washer 70, with centralizing projections 72, located between a nut 74, the underside of a sanitary unit 76, and the base of a tap 78, having a lower stem 80. The resilient projections 72 locate in the space between the hole in the sanitary unit 76 and the stem of the tap. FIG. 10 shows the washer 70 having a recessed portion on its lower edge, into which the nut fits. Screwing the nut up the stem of the tap against the washer causes the projections to centralize the washer within the hole. The stem of the tap is located centrally within the washer and so the tap is centered with respect to the hole in the unit. It is advantageous for the projections to be shaped as shown in FIG. 10, having a convex outside edge. Shaping them in this way and ensuring that they are flexible means that the projections can adapt to a variety of different hole sizes, since if the projections enter a relatively small hole the they are guided radially inwards by virtue of their shape. Since it is advantageous to have flexible projections it is better to have a number of smaller projections, rather than, for example a single cone-shaped projection. It is advantageous to have at least three projections, since this means that the tap can be centered on the hole in two dimensions. An alternative configuration for the projections might be a split cylinder.

Any of the washers shown in the figures can be provided with a thread 52 on the internal surface of the aperture 42. Thus the washer can be threaded onto the tap thread and the need for a separate nut to hold the tap against the unit is eliminated.

The term “article of sanitaryware” as used herein shall be taken to include fixtures, fittings or installations such as, but not limited to, baths, sinks, basins, showers, bidets, water tanks, boilers, toilets and urinals and appliances requiring plumbed connections.

What is claimed is:

1. A washer for use in plumbing in which a pipe member passes through a hole in an article of sanitaryware, creating a gap between the hole and the pipe member, the washer comprising at least one part having a bore defined therein for receiving the pipe member, and at least one projection extending from the washer in a substantially axial direction, for locating in the gap between the pipe member and the article when the washer is urged against the article, so as to centralize the washer substantially with respect to the hole.

2. The washer of claim 1 wherein the at least one projection is arranged so that when the washer is inserted into the hole and the pipe member passes through the washer, the pipe member is located substantially centrally with respect to the hole.

3. The washer of claim 1 wherein the at least one projection is flexible so that it may fit into holes of different sizes.

4. The washer of claim 1 wherein the at least one projection comprises a split ring.

5. The washer of claim 1 wherein the at least one projection comprises a frusto-cone.

6. The washer of claim 1 wherein the at least one projection is resiliently biased radially outwardly against the hole.

7. The washer of claim 1 wherein the bore is substantially circular.

8. The washer of claim 1 wherein the at least one projection is three projections.

9. The washer of claim 1 wherein at least one of the at least one projection is flexible and has at least one substantially flat bearing surface for bearing against an interior of the hole.

10. The washer of claim 1 wherein the interior surface of the bore in the washer is threaded for engagement with a pipe.

11. The washer of claim 1 further comprising at least first and second parts, the parts being movable with respect to each other between a first configuration in which they define the bore, such that in use the washer may enclose the pipe member, and a second configuration in which the pipe member may be inserted into or withdrawn from the bore generally radially.

12. The washer of claim 11 wherein the parts are completely separable.

13. The washer of claim 11 wherein the parts include releasable latch means for allowing the parts to releasably engage each other.

14. The washer of claim 11 wherein the parts are hingedly attached at an edge region of the washer.

15. The washer of claim 14 wherein the parts are held together in the first, closed configuration by releasable latch means.

16. The washer of claim 15 wherein the releasable latch means comprises a projection and socket.

17. The washer of claim 11 wherein the parts of the washer are permanently attached together in one region and are flexible so that the two parts can be urged apart to adopt the second, open configuration.

18. The washer of claim 17 wherein the two parts may be flexed apart in a direction substantially parallel to the axis of the bore.

19. The washer of claim 11 wherein the two parts of the washer are made of plastic and are formed as one piece of plastic.

20. The washer of claim 11 wherein the washer includes a slot located between the two parts of the washer, which slot may be used for prising apart the two parts of the washer.

21. The washer of claim 11 wherein an internal surface of the bore is threaded.
